(19) United States
(12) Patent Application Publication
(10) Pub. No.: US 2014/0003470 A1
(43) Pub. Date: Jan. 2, 2014

(54) UNIFIED RECEIVER FOR MULTI-USER DETECTION

(71) Applicant: Qualcomm Incorporated, San Diego, CA (US)

(72) Inventor: Qiang Shen, San Diego, CA (US)

(21) Appl. No.: 13/664,668

(22) Filed: Oct. 31, 2012

Related U.S. Application Data
(60) Provisional application No. 61/665,237, filed on Jun. 27, 2012.

(51) Int. Cl. H04B 1/7103

(52) U.S. Cl. CPC H04B 1/7103
USPC 375/148

(57) ABSTRACT

In a user equipment, a unified receiver structure may be specified as both an equalizer and a multi-user detector. That is, the receiver may transfer between an equalizer and a multi-user detector within the same structure. A received signal may be estimated using the combined equalizer and multi-user detector unit.

### CROSS REFERENCE TO RELATED APPLICATION

This application claims the benefit of U.S. provisional patent application No. 61/665,237 filed Jun. 27, 2012 entitled “UNIFIED RECEIVER FOR MULTI-USER DETECTION AND EQUALIZATION, the disclosure of which is expressly incorporated herein by reference in its entirety.

### BACKGROUND

1. Field

Aspects of the present disclosure relate generally to wireless communication systems, and more particularly, to a unified receiver for multi-user detection in a TD-SCDMA network.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect, a method of wireless communication is presented. The method includes receiving a signal at a receiver. The method further includes estimating the received signal via a common receiver unit comprising channel equalizer and a multi-user detector (MUD).

According to another aspect, an apparatus for wireless communication is presented. The apparatus includes means for receiving a signal at a receiver. The apparatus further includes means for estimating the received signal via a common receiver unit comprising channel equalizer and a multi-user detector.

According to yet another aspect, a computer program product for wireless communication in a wireless network is presented. The computer program includes a non-transitory computer-readable medium having non-transitory program code recorded thereon, the program code includes program code to receive a signal at a receiver. The program code further includes program code to estimate the received signal via a common receiver unit comprising channel equalizer and a multi-user detector.

According to still yet another aspect, an apparatus for wireless communication is presented. The apparatus includes a memory a processor coupled to the memory. The processor being configured to receive a signal at a receiver and to estimate the received signal via a common receiver unit comprising channel equalizer and a multi-user detector.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIGS. 4 and 5 are block diagrams illustrating a unified receiver according to aspects of the present disclosure.

FIG. 6 is a block diagram illustrating a method for estimating a channel via a unified receiver according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

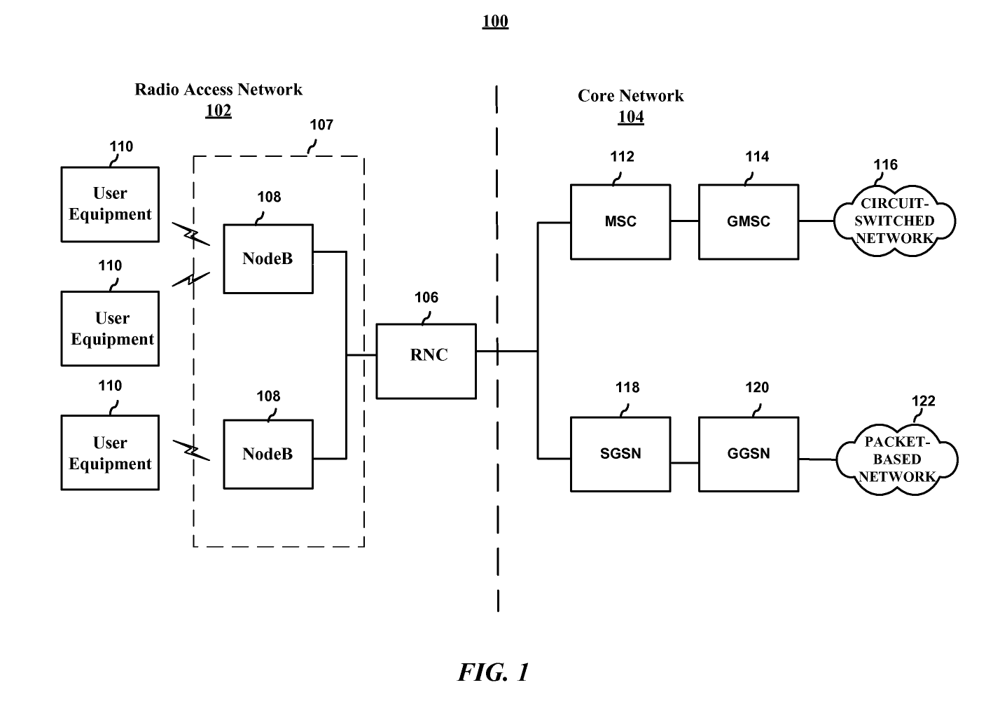

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

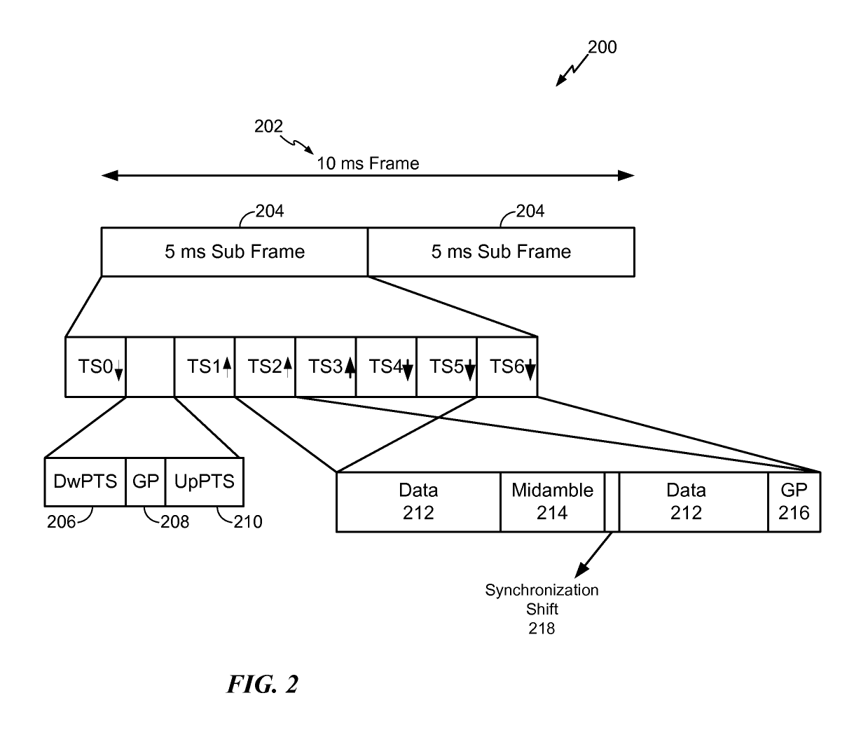

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

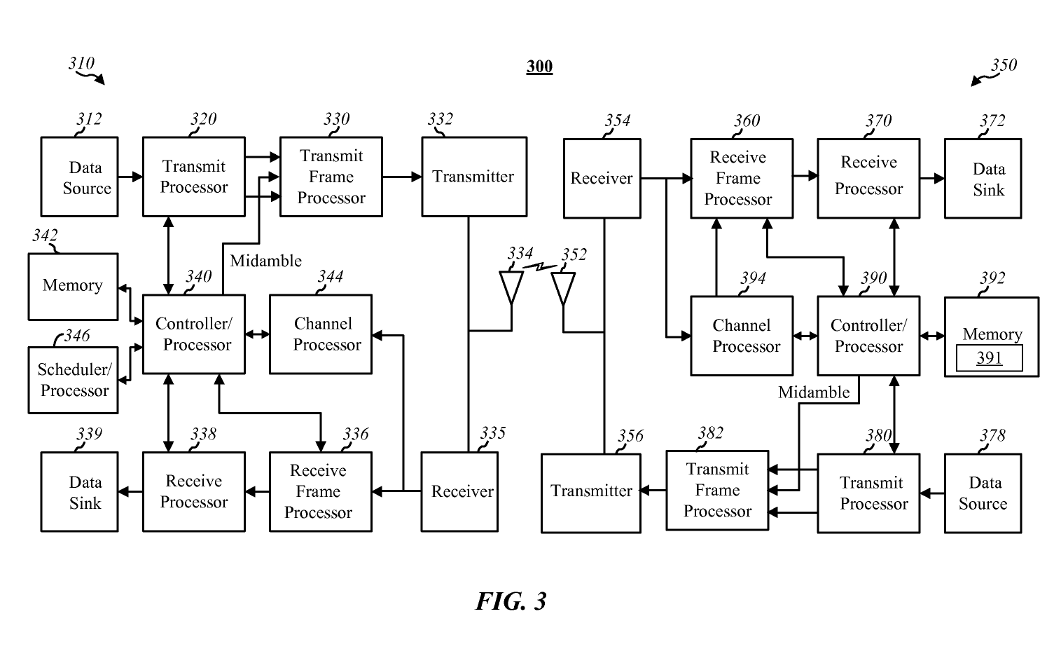

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a unified receiver module 391 which, when executed by the controller/processor 390, configures the UE 350 for performing channel estimation. A scheduler/processor 346 at the node B 310 may be used to allocate resources to the UEs and schedule downlink and/or uplink transmissions for the UEs.

Unified Receiver For Multi-User Detection

In wireless communication systems with multi-user access, it may be desirable for the receiver to perform joint detection of the signals received from the users to improve the interference cancellation. The joint detection may be referred to as multi-user detection.

Systems such as CDMA, WCDMA, and TD-SCDMA use orthogonal codes and scrambling codes to spread information symbols before they are transmitted. A multi-user detector combines the information of a user spreading code, an orthogonal code, channel impulse response, and signal power variation to perform an improved signal detection and/or estimation, based on certain criteria, such as a minimum mean square error (MMSE).

In a conventional system, a channel equalizer may be used to estimate a signal in the presence of multipath caused by time dispersion in a propagation channel. The equalizer may be MMSE based but typically does not consider a code structure (e.g., spreading code and orthogonal code). Still, the equalizer may consider the presence of other users' signals in addition to noise by including the users' signals in the signal covariance matrix that is used in equalizer weight calculation.

In some cases, an equalizer may be desirable in a receiver with a multi-user detector. That is, in some cases, an equalizer may achieve the same performance as a multi-user joint detector, while being less computationally complex. Accordingly, the equalizer may be desirable in a receiver with a multi-user detector as a trade-off between power cost and performance.

Typically, an equalizer does not improve performance when used in lieu of a multi-user detector. Still, in some cases, an equalizer may be desirable when a signal has little to no code structure. In one example, an equalizer may achieve the same performance as a multi-user joint detector when there is little to no code structure in a signal. The signal may have no code structure when a spreading factor is one (e.g., no code spreading). As another example, the equalizer may achieve the same performance as a multi-user joint detector when all orthogonal codes in the code space defined by a unique scrambling code have the same transmission power. In another example, in some cases, an equalizer may have an improved numerical stability in comparison to a multi-user detector.

Accordingly, as discussed above, in certain cases, the benefit of the multi-user detector decreases because an equalizer may have similar or improved performance in comparison to the performance of the multi-user detector. Furthermore, an equalizer may also be desirable because the equalizer may be implemented with a lower complexity in comparison to a multi-user detector.

In a conventional system, the multi-user detector is separate from the equalizer. The multi-user detection combines a channel impulse response with a code structure in a signal modeling. The conventional receiver using the combined channel impulse response with the code structure specifies a structure that is different from an equalizer, therefore, a separate structure is specified for the equalizer

As previously discussed, an equalizer may be preferred when, for example, the received signal has little to no code structure. Still, the code structure of the signal may be unknown until after a channel estimation has been performed. The conventional receiver may switch between the multi-user detector and the equalizer after determining the code structure of the signal. Alternatively, the conventional receiver may simultaneously process the received signal with the multi-user detector and the equalizer until the code structure is determined. Nonetheless, the aforementioned solutions reduce the receiver's efficiency and increase the receiver's implementation and operation costs.

The present disclosure provides a unified receiver structure that can be specified as both an equalizer and a multi-user detector. That is, the receiver may transfer between an equalizer and a multi-user detector within the same structure. According to an aspect, a received signal y may be modeled for both a multi-user detector and an equalizer. EQUATION 1 specifies the modeling of the received signal y for the multi-user detector and the equalizer. EQUATION 1 is as follows:

$$y = {\sum }_{i = 0}^{S - 1} {H}_{i} {C}_{i} W {G}_{i} {s}_{i} + n = {\sum }_{i = 0}^{S - 1} {H}_{i} {x}_{i} + n \qquad ( 1 )$$

In EQUATION 1, the first portion

$${\sum }_{i = 0}^{S - 1} {H}_{i} {C}_{i} W {G}_{i} {s}_{i} + n$$

is for the multi-user detector and specifies the code structure of the signal. The second portion

$${\sum }_{i = 0}^{S - 1} {H}_{i} {x}_{i} + n$$

is for the equalizer and specifies the channel impulse response. In EQUATION 1, H is a channel impulse response, C is a scrambling code, W is an orthogonal code matrix, and G is a code power allocation (e.g., code spectrum). Furthermore, s is the transmitted signal symbol, i is a cell index, and n is noise. Finally, x is a composite signal after orthogonal and scramble code spreading. That is, x is a composite of C, W, G and s.

According to an aspect, using the MMSE criterion, a multi-user detector may estimate s (i.e., calculate an estimate ŝ) and an equalizer may estimate x (i.e., calculate an estimate \hat{x}). These two solutions (e.g., estimating ŝ and estimating \hat{x}) are related, and therefore, the two solutions may be solved via a single receiver.

According to an aspect, the multi-user detector solution is

$$\begin{matrix}\begin{matrix}{\hat{s}}_{i , 0} = E [ {s}_{i} {y}^{H} ] {E [ {yy}^{H} ]}^{- 1} y \\ = {R}_{sy} {R}_{yy}^{- 1} y \\ = {G}_{i} {W}^{H} {C}_{i}^{H} {H}_{i}^{H} {R}_{yy}^{- 1} y\end{matrix} & ( 2 ) \\ \begin{matrix}{R}_{yy} = {E [ {yy}^{H} ]}_{( NQ + L - 1 ) x ( NQ + L - 1 )} \\ = {\sum }_{i = 0}^{S - 1} {H}_{i} {C}_{i} W {G}^{2} {W}^{H} {C}_{i}^{H} {H}_{i}^{H} + {σ}_{w}^{2} {I}_{NQ + L - 1} \\ = {\sum }_{i = 0}^{S - 1} {H}_{i} {C}_{i} [ {I}_{N} ⊗ ( {W}_{Q} {G}_{Q}^{2} {W}_{Q}^{H} ) ] {C}_{i}^{H} {H}_{i}^{H} + {σ}_{w}^{2} {I}_{NQ + L - 1}\end{matrix} & ( 3 ) \\ \begin{matrix}{R}_{sy} = {E [ {s}_{i} {y}^{H} ]}_{Nx ( NQ + L - 1 )} \\ = {G}_{i} {W}^{H} {C}_{i}^{H} {H}_{i}^{H}\end{matrix} & ( 4 )\end{matrix}$$

In EQUATIONS 3 and 4, I is an identity matrix. (NQ+L−1) is the length of the y vector. Q is the spreading sequence length. N is the number of spreading sequences that are transmitted. That is, for example, if N symbols are transmitted that are spread by Q chips, then NQ chips are transmitted. L is the channel delay spread at the receiver side. Thus, the observed number of samples is NQ+L−1.

Due to the toeplitz structure of H, a block toeplitz matrix may be observed for the mulit-user detector weights:

$${H}_{i}^{H} {R}_{yy}^{- 1} = [ \begin{matrix}{f}_{0 , 0} & {f}_{0 , 1} & … & {f}_{0 , Q - 1} & … & {f}_{0 , VQ - 1} & 0 & … & 0 & 0 \\ {f}_{1 , 0} & {f}_{1 , 1} & … & {f}_{1 , Q - 1} & … & {f}_{1 , VQ - 1} & 0 & … & 0 & 0 \\ ⋮ & ⋮ & ⋮ & ⋮ & ⋮ & ⋮ & ⋮ & ⋮ & ⋮ & ⋮ \\ {f}_{Q - 1 , 0} & {f}_{Q - 1 , 1} & … & {f}_{Q - 1 , Q - 1} & … & {f}_{Q - 1 , VQ - 1} & 0 & … & 0 & 0 \\ 0 & … & … & 0 & {f}_{0 , 0} & {f}_{0 , 1} & … & {f}_{0 , VQ - 1} & 0 & 0 \\ & & & 0 & {f}_{1 , 0} & {f}_{1 , 1} & … & {f}_{1 , VQ - 1} & 0 & 0 \\ ⋮ & & ⋮ & ⋮ & … & ⋮ & ⋮ & ⋮ & ⋮ & ⋮ \\ 0 & & & 0 & {f}_{Q - 1 , 0} & {f}_{Q - 1 , 1} & … & {f}_{Q - 1 , VQ - 1} & 0 & 0 \\ ⋮ & … & … & … & … & … & … & … & … & … \\ 0 & … & … & 0 & … & 0 & 0 & {f}_{Q - 1 , 1} & … & {f}_{Q - 1 , VQ - 1}\end{matrix} ] \qquad ( 5 )$$

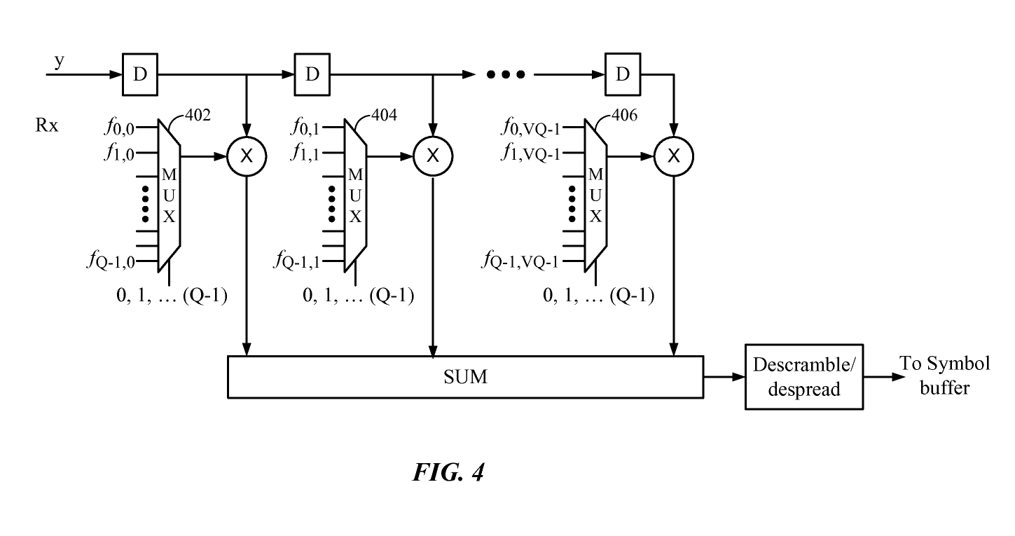

In one aspect, EQUATION 5 may be implemented as a time varying linear filter. FIG. 4 illustrates an implementation of a multi-user detector including a time-varying linear filter concatenated with a despread and descramble unit.

The time varying linear filter may be used as a multi-user detector according to aspects of the disclosure. That is, the filter may solve for GᵢW^{H}Cᵢ^{H}Hᵢ^{H}R_{yy}⁻¹y. Specifically, samples of the signal y received at the antenna Rx are input to the delay units (d-registers (D)) from the sample server. The multiplexor (mux) switches among the filter taps as samples of y are shifted into d-registers. In the present aspect, an equal number of d-registers and multipliers are provided so that each value from the d-register is multiplied by an output of the filter tap.

The value of the filter tap corresponds to values of each column of the matrix of EQUATION 5. For example, in FIG. 4, the first tap of a first mux 402 is f_{0,0} and corresponds to the first value of the first column of the matrix of EQUATION 5. Moreover, the first tap of a second mux 404 is f_{0,1} and corresponds to the first value of the second column of the matrix of EQUATION 5. Furthermore, the first tap of the Q−1 mux 406 is f_{0,VQ-1} and corresponds to the first value of Q−1 column of the matrix of EQUATION 5. Furthermore, filter taps of the multi-user detector are cycled (time varied) from 0 to Q−1 for the rows of the matrix of EQUATION 5.

Thus, according to the present aspect, by cycling through each row of the matrix of EQUATION 5, the output from the filter taps are multiplied by a sample of y from each d-register to generate Hᵢ^{H}R_{yy}⁻¹y. That is, the filter multiplies the received signal y by the matrix of EQUATION 5, the results are summed and then concatenated by the descrambler (Cᵢ^{H}) and despreader (W^{H}) unit to generate GᵢW^{H}Cᵢ^{H}Hᵢ^{H}R_{yy}⁻¹y. It should be noted that G is optional in the filter of FIG. 4 because G is a scalar and is not directly specified for the multi-user detection.

In the filter, a total Q sets of filter taps are periodically clocked for a multi-user detection operation. According to some aspects, Q is equal to 16. These Q sets of tap weights are obtained from EQUATION 5 by selecting (V−1)Q taps out of VQ taps as follows:

$$[ \begin{matrix}{f}_{0 , 0} & {f}_{0 , 1} & … & {f}_{0 , VQ - 1} \\ {f}_{1 , 0} & {f}_{1 , 1} & … & {f}_{1 , VQ - 1} \\ ⋮ & ⋮ & … & ⋮ \\ {f}_{Q - 1 , 0} & {f}_{Q - 1 , 1} & … & {f}_{Q - 1 , VQ - 1}\end{matrix} ] \approx [ \begin{matrix}{q}_{0 , 0} & {q}_{0 , 1} & … & {q}_{0 , ( V - 1 ) Q - 1} & 0 & … & 0 \\ 0 & {q}_{1 , 0} & {q}_{1 , 1} & … & {q}_{1 , ( V - 1 ) Q - 1} & ⋱ & 0 \\ ⋮ & ⋱ & ⋱ & ⋱ & ⋱ & ⋱ & ⋮ \\ 0 & … & 0 & {q}_{Q - 1 , 0} & … & {q}_{Q - 1 , 1} & {q}_{Q - 1 , ( V - 1 ) Q - 1}\end{matrix} ] \qquad ( 6 )$$

According to an aspect, an equalizer solution is as follows:

$${\hat{x}}_{i} = E [ {x}_{i} {y}^{H} ] {E [ {yy}^{H} ]}^{- 1} y = {{H}_{i}^{H} ( {\sum }_{i = 0}^{S - 1} tr ( {G}_{i}^{2} ) {H}_{i} {H}_{i}^{H} + {σ}_{w}^{2} {I}_{NQ + L - 1} )}^{- 1} y \qquad ( 7 )$$

In EQUATION 7, tr is the trace function. When written into a matrix form, a toeplitz matrix is generated:

$${{H}_{i}^{H} ( {\sum }_{i = 0}^{S - 1} tr ( {G}_{i}^{2} ) {H}_{i} {H}_{i}^{H} + {σ}_{w}^{2} {I}_{NQ + L - 1} )}^{- 1} = [ \begin{matrix}{f}_{0} & {f}_{1} & … & {f}_{Q - 1} & … & {f}_{VQ - 1} & 0 & … & 0 & 0 \\ 0 & {f}_{0} & … & {f}_{Q - 2} & … & {f}_{VQ - 2} & {f}_{VQ - 1} & … & 0 & 0 \\ ⋮ & ⋮ & ⋮ & ⋮ & ⋮ & ⋮ & ⋮ & ⋮ & ⋮ & ⋮ \\ 0 & 0 & … & 0 & {f}_{0} & {f}_{1} & … & … & {f}_{VQ - 2} & {f}_{VQ - 1}\end{matrix} ] \qquad ( 8 )$$

In comparison to the matrix of EQUATION 5, the matrix for the equalizer is a time-invariant linear filter. Still, the architecture of FIG. 4 may also be used to perform equalizer functions by keeping the multiplexor index equal to 0 for all samples. That is, the multiplexors of FIG. 4 are not cycled through every filter tap for the equalizer.

The matrix of EQUATION 8 is considered a time-invariant linear filter because the first row is repeated and shifted to the right to generate the other rows of the matrix. Contrary to the matrix of EQUATION 8, the matrix of EQUATION 5 is a block toeplitz, where Q rows and columns are block shifted so that the blocks are repeated. Therefore, because the matrix of the multi-user detector (EQUATION 5) is block repeated, the multi-user detector is a time-variant linear filter.

Accordingly, because the equation for the multi-user detector has been modified (EQUATION 1) the time-varying linear filter structure for multi-user detector may use the same structure as the time-invariant linear filter structure for the equalizer.

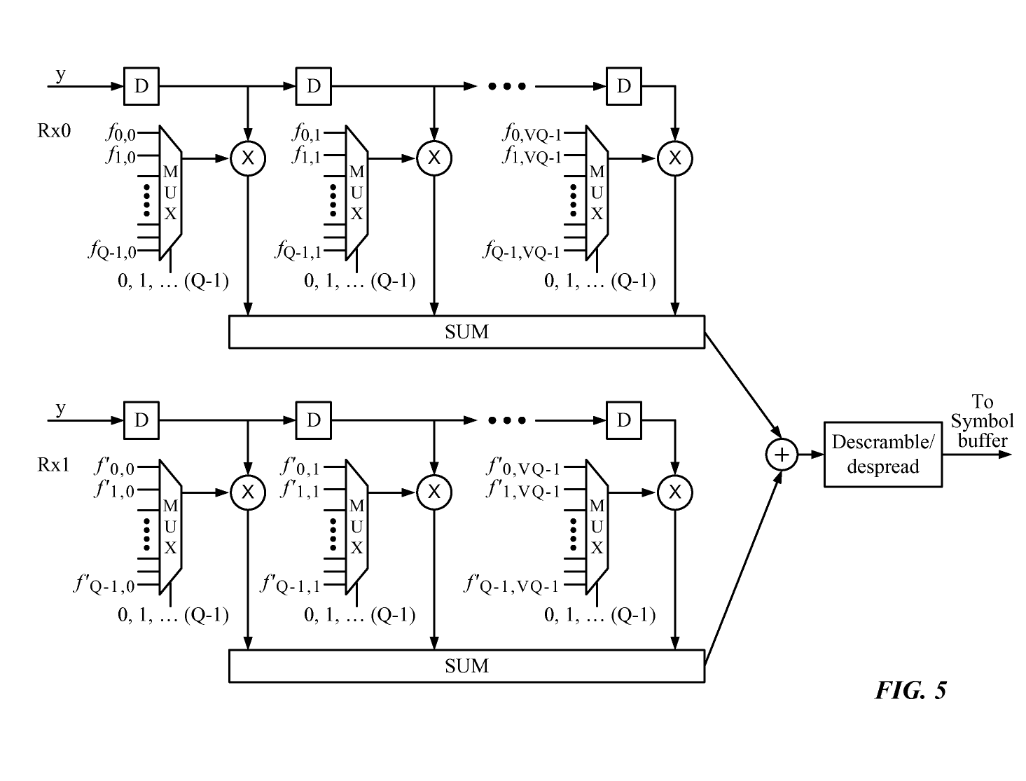

According to another aspect, the unified filter of FIG. 4 may be used with a receiver having more than one antenna. For example, as illustrated in FIG. 5, the filter is contemplated for a system with two receive antennas (Rx0 and Rx1). The filter of FIG. 5 functions for each antenna in the same manner as the filter of FIG. 4 functions for a single antenna.

The receiver architecture of the aspects of the present disclosure is flexible in transferring between a multi-user detector and an equalizer. Furthermore, the receiver architecture of the aspects of the present disclosure is structurally compatible with mixed spreading factors among different cells (e.g., some cells use spreading factor 16 while other cells use spreading factor 1, as with TD-SCDMA). Finally, the receiver architecture of the aspects of the present disclosure has a controllable complexity that is independent of number of active codes.

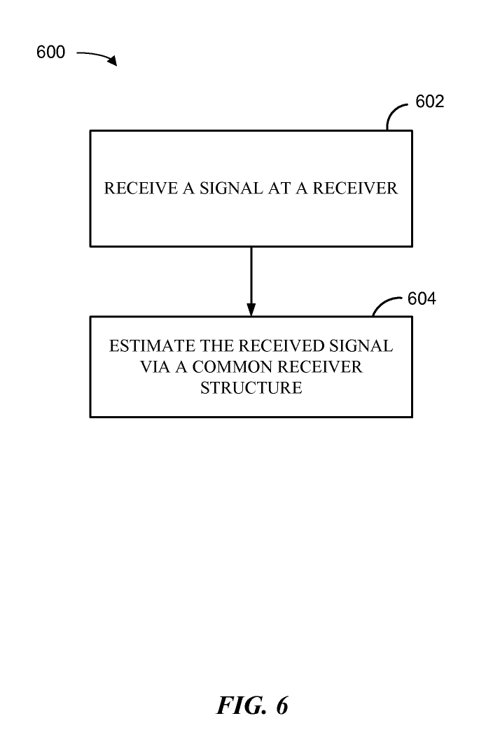

FIG. 6 shows a wireless communication method 600 according to one aspect of the disclosure. A UE receives a signal at a receiver, as shown in block 602. The UE also estimates the received signal via a common receiver structure, the common receiver structure comprising a channel equalizer and a multi-user detector.

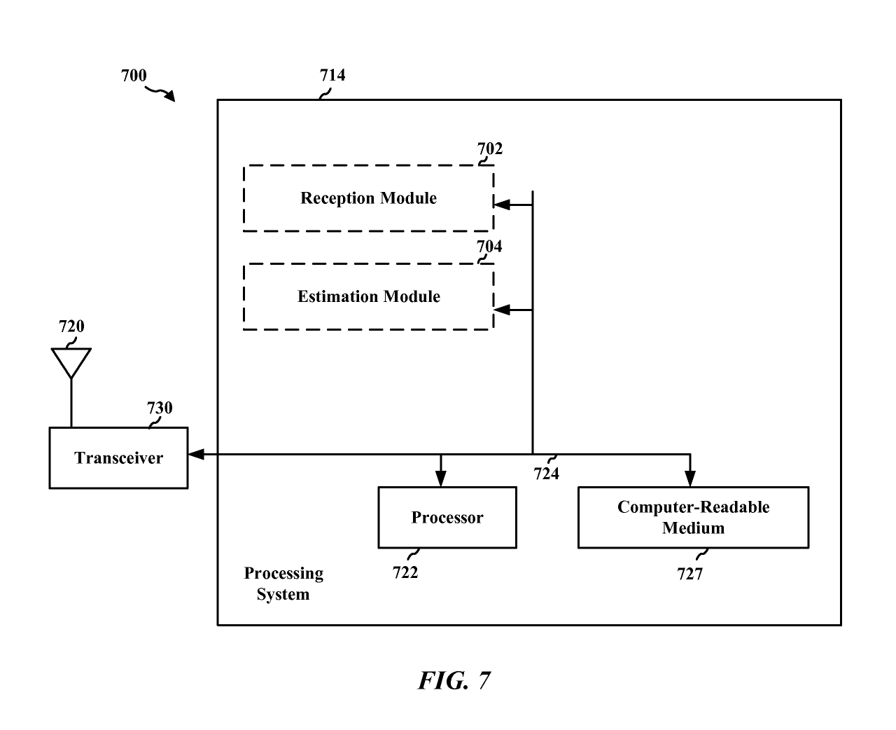

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706 and the computer-readable medium 727. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 727. The processor 722 is responsible for general processing, including the execution of software stored on the computer-readable medium 727. The software, when executed by the processor 722, causes the processing system 714 to perform the various functions described for any particular apparatus. The computer-readable medium 727 may also be used for storing data that is manipulated by the processor 722 when executing software.

The processing system 714 includes a reception module 702 for receiving a signal. The processing system 714 includes an estimation module 704 for estimating the received signal via a common receiver structure The modules may be software modules running in the processor 722, resident/stored in the computer readable medium 727, one or more hardware modules coupled to the processor 722, or some combination thereof The processing system 614 may be a component of the UE 350 and may include the memory 392, and/or the controller/processor 390.

In one configuration, an apparatus such as a UE is configured for wireless communication including means for receiving and means for estimating. In one aspect, the above means may be the antennas 352, the receiver 354, the controller/processor 390, the memory 392, unified receiver module 391, reception module 702, estimation module 704 and/or the processing system 714 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication, comprising:
receiving a signal at a receiver;
estimating the received signal via a common receiver unit comprising a channel equalizer and a multi-user detector (MUD).

2. The method of claim 1, in which the MUD is based at least in part on a channel impulse response, scrambling code, and an orthogonal code of the signal.

3. The method of claim 1, in which:
estimating the received signal via the MUD comprises applying a time varying linear filter to a sample of the received signal
estimating the received signal via the channel equalizer comprises applying a time invariant linear filter to the sample of the received signal; and
estimating the received signal comprises concatenating the received signal via a de-spread and descramble unit.

4. The method of claim 1, in which a complexity of the MUD is not affected by a number of active orthogonal codes of the signal.

5. The method of claim 1, in which the MUD processes multiple cell signals with a plurality of spreading factors.

6. The method of claim 1, in which the MUD processes multiple cell signals in a plurality of modes; at least one of the plurality of modes using an orthogonal code and/or scrambling code information; and at least another one of the plurality of modes not using the orthogonal code and/or scrambling code information.

7. An apparatus for wireless communication, comprising:
means for receiving a signal at a receiver;
means for estimating the received signal via a common receiver unit comprising a channel equalizer and a multi-user detector (MUD).

8. The apparatus of claim 7, in which the MUD is based at least in part on a channel impulse response, scrambling code, and an orthogonal code of the signal.

9. The apparatus of claim 7, in which:
the means for estimating the received signal via the MUD comprises means for applying a time varying linear filter to a sample of the received signal
the means for estimating the received signal via the channel equalizer comprises means for applying a time invariant linear filter to the sample of the received signal; and
the means for estimating the received signal comprises means for concatenating the received signal.

10. The apparatus of claim 7, in which a complexity of the MUD is not affected by a number of active orthogonal codes of the signal.

11. The apparatus of claim 7, in which the MUD processes multiple cell signals with a plurality of spreading factors.

12. The apparatus of claim 7, in which the MUD processes multiple cell signals in a plurality of modes; at least one of the plurality of modes using an orthogonal code and/or scrambling code information; and at least another one of the plurality of modes not using the orthogonal code and/or scrambling code information.

13. A computer program product for wireless communication in a wireless network, comprising:
a non-transitory computer-readable medium having non-transitory program code recorded thereon, the program code comprising:
program code to receive a signal at a receiver;
program code to estimate the received signal via a common receiver unit comprising a channel equalizer and a multi-user detector (MUD).

14. The computer program product of claim 13, in which the MUD is based at least in part on a channel impulse response, scrambling code, and an orthogonal code of the signal.

15. The computer program product of claim 13, in which the program code to estimate the received signal further comprises:
program code to apply a time varying linear filter to a sample of the received signal when using the MUD;
program code to apply a time invariant linear filter to the sample of the received signal when using the channel estimator; and
program code to concatenate the received signal via a de-spread and descramble unit.

16. The computer program product of claim 13, in which a complexity of the MUD is not affected by a number of active orthogonal codes of the signal.

17. The computer program product of claim 13, in which the MUD processes multiple cell signals with a plurality of spreading factors.

18. The computer program product of claim 13, in which the MUD processes multiple cell signals in a plurality of modes; at least one of the plurality of modes using an orthogonal code and/or scrambling code information; and at least another one of the plurality of modes not using the orthogonal code and/or scrambling code information.

19. An apparatus for wireless communication, comprising:
a memory; and
at least one processor coupled to the memory, the at least one processor being configured:
to receive a signal at a receiver;
to estimate the received signal via a common receiver unit comprising a channel equalizer and a multi-user detector (MUD).

20. The apparatus of claim 19, in which the MUD is based at least in part on a channel impulse response, scrambling code, and an orthogonal code of the signal.

21. The apparatus of claim 19, the at least one processor is further configured to
to apply a time varying linear filter to a sample of the received signal when using the MUD;
to apply a time invariant linear filter to the sample of the received signal when using the channel estimator; and
to concatenate the received signal via a de-spread and descramble unit.

22. The apparatus of claim 19, in which a complexity of the MUD is not affected by a number of active orthogonal codes of the signal.

23. The apparatus of claim 19, in which the MUD processes multiple cell signals with a plurality of spreading factors.

24. The apparatus of claim 19, in which the MUD processes multiple cell signals in a plurality of modes; at least one of the plurality of modes using an orthogonal code and/or scrambling code information; and at least another one of the plurality of modes not using the orthogonal code and/or scrambling code information.
